(19) United States
(12) Patent Application Publication
(10) Pub. No.: US 2010/0182429 A1
(43) Pub. Date: Jul. 22, 2010

(54) Monitor Observation System and its Observation Control Method

(76) Inventor: Wol Sup Kim, Seongnam Si (KR)

Correspondence Address: PARK LAW FIRM, 3255 WILSHIRE BLVD, SUITE 1110, LOS ANGELES, CA, 90010, US

(21) Appl. No.: 12/407,614

(22) Filed: Mar. 19, 2009

(30) Foreign Application Priority Data
Jan. 21, 2009 (KR) 10-2009-0004987

(51) Int. Cl. H04N 7/18

(52) U.S. Cl. 348/143; 348/E05.024

(57) ABSTRACT

The present invention implements a monitor observation system, comprising: an external device installed in an observation object area to output a trigger signal in accordance with an input signal source; and a monitor device for detecting the trigger signal outputted from the external device, checking whether the trigger signal conforms to a preset trigger signal condition or not, if so, outputting a corresponding warning sound, and performing transition to the screen conforming to the preset trigger signal condition for displaying.

### BACKGROUND OF THE INVENTION

1. Field of the Invention

The present invention relates to a monitor observation system and its observation control method, and more particularly, to a monitor observation system, which allows a user to quickly check if something is wrong with an observation object area and conduct intensive management by identifying a trigger signal outputted from various external devices installed in an observation object area, outputting a corresponding warning sound upon occurrence of an event, and performing screen transition for the corresponding area on a monitor device, and its observation control method.

2. Discussion of the Related Art

Generally, an observation system using a monitor is a series of devices that are adapted to observe if something is wrong with the inside of an observation zone by using a typical surveillance camera. In such a monitor observation system, a surveillance camera is installed in a place where it can watch, a video signal shot by the surveillance camera is transmitted to a monitor device, an image of the inside of the monitoring zone shot by the surveillance camera in the monitor observation system is displayed on the monitor device, and a user can check the occurrence of an abnormal state, such as burglary or fire, while continuously watching a screen displayed on the monitor device.

A conventional monitor observation system includes, as shown in FIG. 1, a plurality of surveillance cameras 1, an image reproduction apparatus 2, and a monitor 3. The plurality of surveillance cameras transmit an image signal shot for a corresponding monitoring zone to the image reproduction apparatus, and the plurality of surveillance cameras are provided with a separate adaptor or the like to receive power required for driving.

The image reproduction apparatus enables the use of a video cassette recorder (VCR). The image reproduction apparatus includes a recording unit for recording image signals shot by the plurality of cameras on a recording medium, such as a magnetic tape, in accordance with a control program stored in a memory unit and a reproduction unit for outputting an image recorded on the recording medium to the monitor. The image reproduction apparatus is provided with a screen split function for splitting a monitor screen into a plurality of screens, i.e., splitting an image in quarters or sixteenths and reproducing it when displaying an image signal transmitted from each of the surveillance cameras through the monitor.

The monitor is adapted to be controlled by the image reproduction apparatus, and can display an image signal outputted from the image reproduction apparatus on multiple split screens.

The conventional monitor observation system simply functions to display images shot by the plurality of surveillance cameras through the monitor. However, upon occurrence of an abnormal state (hereinafter, referred to as an ‘event’) indicating the control or not of entry and exit through a gate, the sensing or not of a dynamic movement, and a fire alarm, the system has no function of transition to the screen of a surveillance camera that has recognized the occurrence of an event, but splits a screen, which is outputted by the image reproduction apparatus only from the signal source of the surveillance camera, into multiple screens and displays an image shot by the surveillance camera through the small split screens.

Therefore, in order to observe the occurrence or not of an event through the conventional monitor observation system, the user itself has to watch a monitor image split and output in multiple screens at all times, thus making it difficult to do concentrated observation. Due to this, the user becomes more fatigued, thus making the operation considerably inefficient, and if the user is negligent in paying attention even for a little while, he or she is not able to check the occurrence or not of an event outputted to the monitor device.

### SUMMARY OF THE INVENTION

The present invention has been made in an effort to solve the problems occurring in the related art, and it is an object of the present invention to allow a user to deal quickly with the occurrence of an event and perform intensive management of an observation object area since a warning sound conforming to the user's trigger signal setting condition is generated in the event of various types of events and, at this time, an instantaneous transition to the screen where an event has occurred takes place.

In order to solve the above problems, the present invention implements a monitor observation system, comprising: an external device installed in an observation object area to output a trigger signal in accordance with an input signal source; and a monitor device for detecting the trigger signal outputted from the external device, checking whether the trigger signal conforms to a preset trigger signal condition or not, if so, outputting a corresponding warning sound, and performing transition to the screen conforming to the preset trigger signal condition for displaying.

The monitor device comprises: a trigger signal input unit connected to the external device to receive a trigger signal outputted from the external device; a trigger signal setting unit for setting a condition for a trigger signal in a way that the user wants so that a corresponding warning sound is outputted and a corresponding screen setting is done; a control unit for checking from which signal source the trigger signal outputted from the external device is inputted, judging whether the trigger signal conforms to the preset trigger signal setting condition stored in the memory unit or not, and, if so, outputting a warning sound conforming to the preset trigger signal setting condition and performing transition to the screen conforming to the preset trigger signal setting condition; a memory unit for storing information on the trigger signal setting condition preset through the trigger signal setting unit and storing condition information of the signal source of the trigger signal from the external device; a screen output unit for receiving a control signal from the control unit and displaying an image signal in accordance with the preset trigger signal setting condition; and a warning sound generating unit for receiving a control signal from the control unit and outputting a warning sound in accordance with the preset trigger signal setting condition.

The trigger signal setting unit comprises: a trigger function setting unit for determining whether to use a trigger function or not; a trigger type setting unit for determining whether to use an external or internal trigger; a trigger input setting unit for determining in which manner a trigger signal is to be inputted; a warning sound output setting unit for determining whether to use a warning sound or not; a trigger time setting unit for determining a trigger time; a trigger option setting unit for determining an input signal of a trigger; and a display type setting unit for determining a monitor screen output pattern.

Additionally, the present invention implements an observation control method of a monitor observation system, comprising the steps of: receiving a trigger signal outputted from an external device through a trigger signal input unit of a monitor device; judging from which signal source, among a Normal Open signal, a Normal Close signal, a High Level signal, and a Low Level signal, the trigger signal is inputted; judging whether identified condition information of the trigger signal outputted from the external device conforms to information of the preset trigger setting condition stored in the memory unit or not; and upon receipt of the condition information of the trigger signal source, outputting a warning sound conforming the preset trigger setting condition stored in the memory unit and performing transition to the screen conforming to the preset trigger setting condition stored in the memory unit.

The present invention allows a user to deal quickly with the occurrence of an event because the occurrence or not of an event in an observation object area is quickly checked by using a trigger signal outputted from an external device installed in the corresponding area, and is able to quickly check the occurrence or not of an event even if the user does not watch the screen of a monitor device at all times, thereby improving the user's convenience and the efficiency of the observation work.

### BRIEF DESCRIPTION OF THE DRAWINGS

The present invention will become more fully understood from the detailed description given herein below and the accompanying drawings, which are given by illustration only, and thus are not limitative of the present invention, and wherein:

FIG. 1 is a configuration view showing a conventional monitor observation system;

FIG. 2 is an overall configuration view showing a monitor observation system which is applied to the present invention;

FIG. 3 is an illustration showing trigger signal options of the monitor observation system which is applied to the present invention;

FIG. 4 is a flow chart showing an observation control process of the monitor observation system which is applied to the present invention; and

FIG. 5 is an illustration showing a trigger signal setting unit of the monitor observation system which is applied to the present invention.

### DETAILED DESCRIPTION OF THE PREFERRED EMBODIMENTS

Hereinafter, a monitor observation system and its observation control method, which are applied to the present invention, will be described in detail with reference to the accompanying drawings.

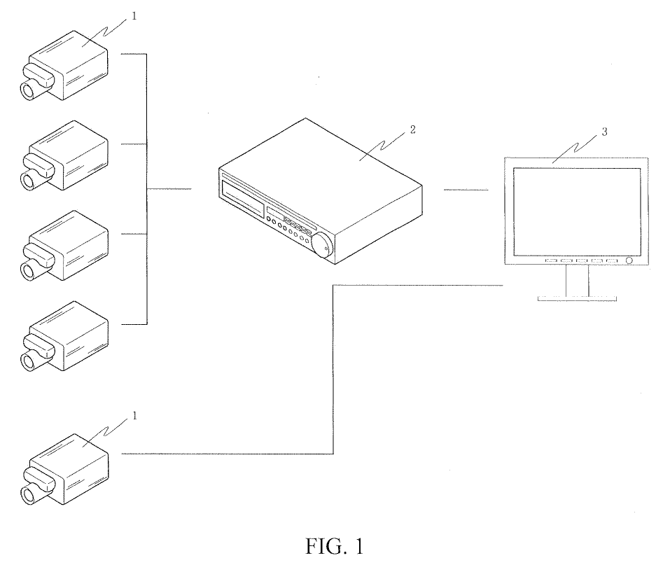

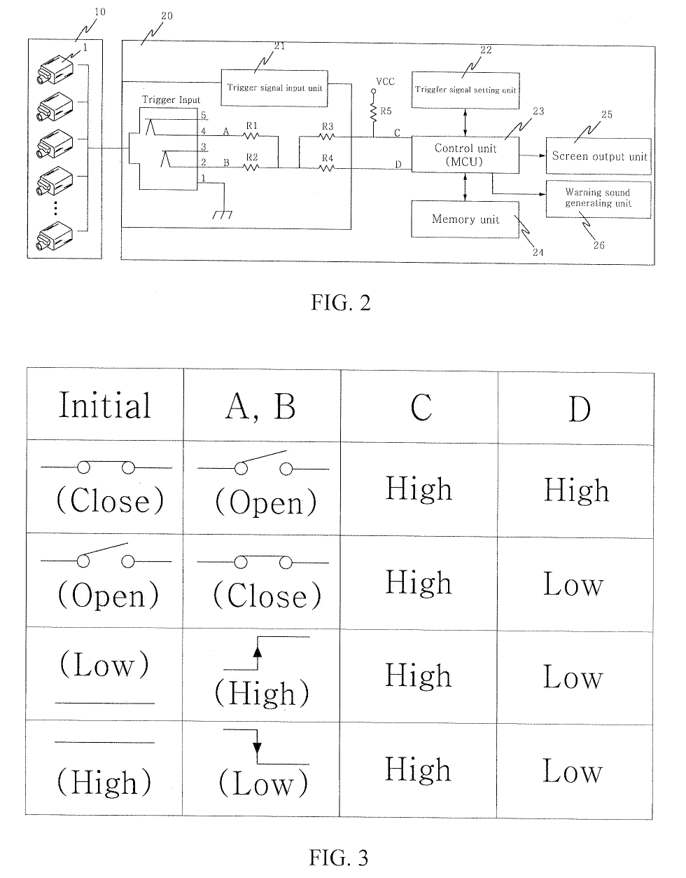

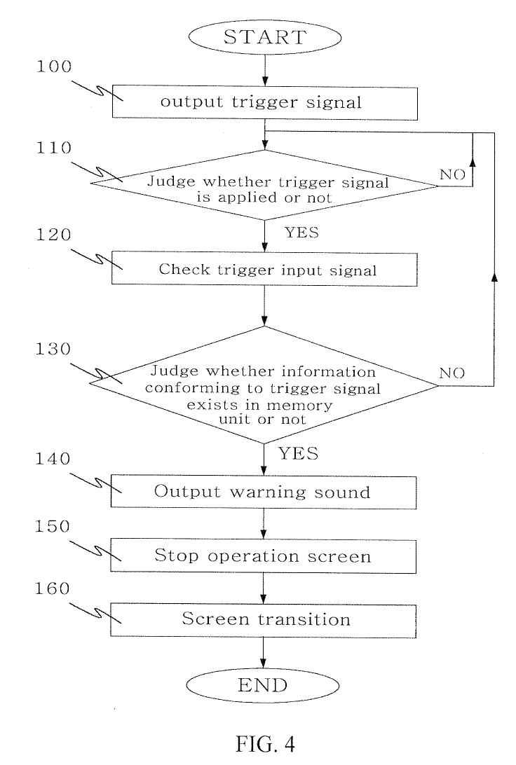

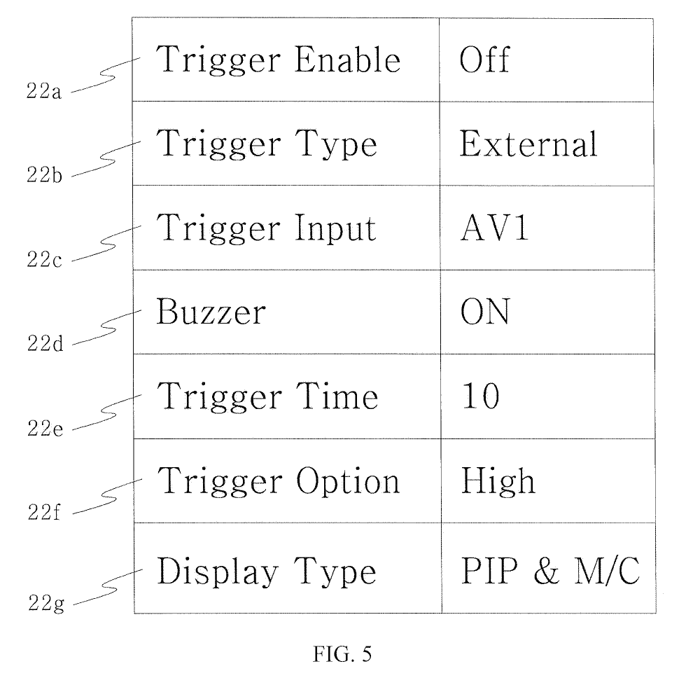

FIG. 1 is a configuration view showing a conventional monitor observation system. FIG. 2 is an overall configuration view showing a monitor observation system which is applied to the present invention. FIG. 3 is an illustration showing trigger signal options of the monitor observation system which is applied to the present invention. FIG. 4 is a flow chart showing an observation control process of the monitor observation system which is applied to the present invention. FIG. 5 is an illustration showing a trigger signal setting unit of the monitor observation system which is applied to the present invention. Reference numeral 1 is a surveillance camera, reference numeral 2 is an image reproduction apparatus, and reference numeral 3 is a monitor.

As shown therein, a monitor device 20 according to the present invention is configured to receive a trigger signal outputted from an external device 10 comprising a plurality of surveillance cameras and the like, recognize the trigger signal and determines whether the trigger signal conforms to a preset trigger signal condition, and, if so, generate a warning sound and perform transition to the screen conforming to the preset trigger signal condition.

The external device 10 comprises a plurality of surveillance cameras and detection sensors that are installed in their respective observation object areas, and outputs, as a trigger signal, an image signal that has picked up a certain observation area or a detection signal that has detected a movement.

The monitor device 20 identifies a trigger signal transmitted from the external device 10 and checks whether the trigger signal conforms to a preset trigger signal condition, if so, outputting a corresponding warning sound, and perform transition to the screen conforming to the preset trigger signal condition for displaying through a monitor. The monitor device 20 comprises a trigger signal input unit 21, a trigger signal setting unit 22, a control unit 23, a memory unit 24, a screen output unit 25, and a warning sound generating unit 26.

The trigger signal input unit 21 is an input port which is electrically connected to the external device 10 and receives a trigger signal outputted from the external device.

The trigger signal setting unit 22 sets a condition of a trigger signal in a way the user wants so that a corresponding warning sound is outputted and a corresponding screen setting is done, and enables information on the set condition for a trigger signal to be stored in the memory unit 24 so as to check whether the information conforms to the condition of a trigger signal outputted from the external device 10 or not.

The conditions that can be set through the trigger signal setting unit 22 are as follows. That is, the trigger signal setting unit 22 includes a trigger function setting unit 22a for determining whether to use a trigger function or not, a trigger type setting unit 22b for determining whether to use an external or internal trigger, a trigger input setting unit 22c for determining in which manner, among a composite signal, SVHS (SVideo) signal, a component signal, an HDMI (High Definition Multimedia Interface) signal, a DVI (Digital Video Interface) signal, and a VGA (Video Graphic Array) signal, a trigger signal is to be inputted, a warning sound output setting unit 22d for determining whether to use a warning sound or not, a trigger time setting unit 22e for determining a trigger time, a trigger option setting unit 22f for determining an input signal of a trigger among a Normal Open signal, a Normal Close signal, a High Level signal, and a Low Level signal, and a display type setting unit 22g for determining a monitor screen output pattern between a PIP (Picture in Picture) and Main source change and a Main source change.

The control unit 23 checks from which signal source, among a Normal Open signal, a Normal Close signal, a High Level signal, and a Low Level signal, the trigger signal outputted from the external device 10 and received through the trigger signal input unit 21 is inputted, and judges whether the trigger signal conforms to the preset trigger signal setting condition stored in the memory unit 24. Then, if the condition of the trigger signal source and the trigger signal setting condition stored in the memory unit 24 conform to each other, the control unit 23 outputs a warning sound through the warning sound generating unit 26, and controls the corresponding component so as to perform transition to the screen conforming to the preset trigger signal setting condition.

The memory unit 24 stores information on the trigger signal setting condition preset through the trigger signal setting unit 22, stores condition information of the signal source of the trigger signal from the external device 10 which is detected through the control unit 23, and provides the corresponding information according to a control signal from the control unit.

The screen output unit 25 receives a control signal from the control unit 23 to display an image signal in a full screen or in split screens in accordance with the preset trigger signal setting condition.

The warning sound generating unit 26 receives a control signal from the control unit 23 to output a warning sound of a certain type through a speaker.

An observation control method of the monitor observation system constructed as above according to one embodiment of the present invention will be described.

When a trigger signal is outputted from the external device, such as the surveillance cameras, detection sensors, and the like that are installed in observation object areas (100), the monitor device receives a trigger signal from the trigger signal input unit and judges whether the trigger signal is applied or not (110) and the control unit checks by comparative judgment from which signal source the trigger input signal is inputted (120).

In other words, as shown in FIG. 2, in accordance with the trigger signal condition of “A,B” of the trigger signal input unit 21, the signal source is fixed at “High” in the “C” entry of the control unit 23 by applying power at all times, while the signal source is set to “High” or “Low” in the “D” entry of the control unit and stored in the memory unit by comparatively judging the condition of “A,B” and a signal applied to the “C” entry.

The control unit 23 searches the memory unit 24 to comparatively judge whether or not there exists information of a preset trigger setting condition, which is identical to identified condition information of the trigger signal outputted from the external device 10 (130). Then, when the identified condition information of the trigger signal source is applied, the control unit 23 applies a control signal to the warning sound generating unit to output a corresponding warning sound through a speaker (140), applies a control signal to the screen output unit to stop the operation screen being displayed (150), and performs transition to the screen conforming to the preset trigger setting condition stored in the memory unit (160), thereby enabling it to conduct intensive management of an observation object area where an event has occurred.

As seen from above, the present invention can achieve intensive management by quickly checking various types of events that occur in an observation object area by using a trigger signal outputted from an external device.

Although the present invention has been described in connection with the embodiment illustrated in the drawings, it will be apparent to those skilled in the art that various substitutions, modifications and changes may be made thereto without departing from the technical spirit and scope of the invention. Thus, the present invention is not limited to the embodiment and the accompanying drawings.

What is claimed is:

1. A monitor observation system, comprising:
an external device installed in an observation object area to output a trigger signal in accordance with an input signal source; and
a monitor device for detecting the trigger signal outputted from the external device, checking whether the trigger signal conforms to a preset trigger signal condition or not, if so, outputting a corresponding warning sound, and performing transition to the screen conforming to the preset trigger signal condition for displaying.

2. The monitor observation system of claim 1, wherein the monitor device comprises:
a trigger signal input unit connected to the external device to receive a trigger signal outputted from the external device;
a trigger signal setting unit for setting a condition for a trigger signal in a way that the user wants so that a corresponding warning sound is outputted and a corresponding screen setting is done;
a control unit for checking from which signal source the trigger signal outputted from the external device is inputted, judging whether the trigger signal conforms to the preset trigger signal setting condition stored in the memory unit or not, and, if so, outputting a warning sound conforming to the preset trigger signal setting condition and performing transition to the screen conforming to the preset trigger signal setting condition;
a memory unit for storing information on the trigger signal setting condition preset through the trigger signal setting unit and storing condition information of the signal source of the trigger signal from the external device;
a screen output unit for receiving a control signal from the control unit and displaying an image signal in accordance with the preset trigger signal setting condition; and
a warning sound generating unit for receiving a control signal from the control unit and outputting a warning sound in accordance with the preset trigger signal setting condition.

3. The monitor observation system of claim 2, wherein the trigger signal setting unit comprises:
a trigger function setting unit for determining whether to use a trigger function or not;
a trigger type setting unit for determining whether to use an external or internal trigger;
a trigger input setting unit for determining in which manner a trigger signal is to be inputted; a warning sound output setting unit for determining whether to use a warning sound or not;
a trigger time setting unit for determining a trigger time;
a trigger option setting unit for determining an input signal of a trigger; and
a display type setting unit for determining a monitor screen output pattern.

4. An observation control method of a monitor observation system, comprising the steps of:
receiving a trigger signal outputted from an external device through a trigger signal input unit of a monitor device;
judging from which signal source, among a Normal Open signal, a Normal Close signal, a High Level signal, and a Low Level signal, the trigger signal is inputted;
judging whether identified condition information of the trigger signal outputted from the external device conforms to information of the preset trigger setting condition stored in the memory unit or not; and
upon receipt of the condition information of the trigger signal source, outputting a warning sound conforming the preset trigger setting condition stored in the memory unit and performing transition to the screen conforming to the preset trigger setting condition stored in the memory unit.
